(19) United States
(12) Patent Application Publication
(10) Pub. No.: US 2014/0295063 A1
(43) Pub. Date: Oct. 2, 2014

(54) METHOD OF MANUFACTURING A CAPACATIVE TOUCH SENSOR CIRCUIT USING A ROLL-TO-ROLL PROCESS TO PRINT A CONDUCTIVE MICROSCOPIC PATTERNS ON A FLEXIBLE DIELECTRIC SUBSTRATE

(71) Applicant: UNIPIXEL DISPLAYS, INC., The Woodlands, TX (US)

(72) Inventors: Robert J. Petcavich, The Woodlands, TX (US); Ed S. Ramakrishnan, The Woodlands, TX (US); Daniel K. Van Ostrand, The Woodlands, TX (US); Reed Killion, The Woodlands, TX (US); Kevin J. Derichs, The Woodlands, TX (US)

(21) Appl. No.: 14/354,513

(22) PCT Filed: Oct. 25, 2012
(86) PCT No.: PCT/US2012/061787

§ 371 Date: Apr. 25, 2014

Related U.S. Application Data
(60) Provisional application No. 61/551,071, filed on Oct. 25, 2011.

(51) Int. Cl. G06F 3/044

(52) U.S. Cl. CPC G06F 3/044
USPC 427/79

(57) ABSTRACT

Mutual capacitance touch sensor circuits are used in manufacturing displays, including touch screen displays, such as LED, LCD, plasma, 3D, and other displays used in computing as well as stationary and portable electronic devices. A flexographic printing process may be used, for example, in a roll to roll handling system to print geometric patterns on a substrate, for example, a flexible dielectric substrate. These patterns may then be coated with a conductive material by, for example, an electroless plating process.

### CROSS-REFERENCE TO RELATED APPLICATION

The present application claims priority to U.S. Provisional Patent Application No. 61/551,071, filed on Oct. 25, 2011 (Attorney Docket No. 2911-02200); which is hereby incorporated herein by reference.

### BACKGROUND

Touch screens are visual displays with areas that may be configured to detect both the presence and location of a touch by, for example, a finger, a hand, or a stylus. Touch screens may be found in televisions, computers, mobile computing devices, and game consoles. Touch screens may allow users to interact directly through the display, without requiring a peripheral device such as a mouse or a track pad or an intermediate electronic device. There are a variety of touch screen technologies available including resistive, surface acoustic waves, capacitive, mutual capacitance, surface capacitance, projected capacitance, infrared, and optical imaging. These technologies may be used in displays including LCD, LED, plasma, touch screen, and 3D.

### SUMMARY

Disclosed herein is a method of producing a mutual capacitance touch sensor by flexographic printing comprising: cleaning a dielectric substrate; printing a first pattern on a first side of the dielectric substrate, wherein the first pattern is printed using a first master plate and curing the printed dielectric substrate. The embodiment further comprising printing a second pattern on a second side of the dielectric substrate, wherein the second pattern is printed using a second master plate.

In another embodiment, a method of producing a mutual capacitance touch sensor comprising a dielectric substrate; printing, by a flexographic printing process using at least a first master plate and a first ink, a first pattern on a first side of a dielectric substrate; and curing the printed dielectric substrate. The embodiment further comprising printing, by a flexographic printing process using at least a second master plate and a second ink, a second pattern on a second side of the dielectric substrate, wherein the second pattern is printed using a second master plate and a second ink; curing, subsequent to printing the second pattern, the printed dielectric substrate; and depositing, by an electroless plating process, a conductive material on the first and the second patterned surfaces.

In an alternate embodiment, a method of producing a mutual capacitance touch sensor by flexographic printing comprising: printing, by a first print module, a first pattern on a first side of the dielectric substrate; curing the printed dielectric substrate; depositing, by an electroless plating process, a conductive material on the first patterned surface. The embodiment further comprising printing, by a second print module, a second pattern on a second side of the dielectric substrate; curing, subsequent to printing the second pattern, the printed dielectric substrate; depositing, by the electroless plating process, a conductive material on the second microstructural pattern.

### BRIEF DESCRIPTION OF THE DRAWINGS

For a detailed description of exemplary embodiments of the invention, reference will now be made to the accompanying drawings in which:

FIGS. 1A-1C are embodiments of flexo-masters.

FIGS. 2A-2B are embodiments of a top view of a printed circuit.

FIG. 3 is an embodiment of a system for fabricating a conductive microscopic pattern on a flexible dielectric substrate.

FIGS. 4A-4B are embodiments of metered printing processes.

FIGS. 5A-5B are isometric and cross sectional views of an embodiments of a capacitive touch sensor.

FIG. 6 is a top view of an embodiment of a circuit printed on a thin flexible transparent substrate.

FIG. 7 is an embodiment of a method of manufacturing a mutual capacitance touch sensor.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are embodiments of a system and a method to fabricate a mutual capacitance flexible touch sensor (FTS) circuit by, for example, a roll-to-roll manufacturing process. A plurality of master plates may be fabricated using thermal imaging of selected designs in order print high resolution conductive lines on a substrate. A first pattern may be printed using a first roll on a first side of the substrate, and a second pattern may be printed using a second roll on a second side of the substrate. Electroless plating may be used during the plating process. While electroless plating may be more time consuming than other methods, it may be better for small, complicated, or intricate geometries. The FTS may comprise a plurality of thin flexible electrodes in communication with a dielectric layer. An extended tail comprising electrical leads may be attached to the electrodes and there may be an electrical connector in electrical communication with the leads. The roll-to-roll process refers to the fact that the flexible substrate is loaded on to a first roll, which may also be referred to as an unwinding roll, to feed it into the system where the fabrication process occurs, and then unloaded on to a second roll, which may also be referred to as a winding roll, when the process is complete.

Touch sensors may be manufactured using a thin flexible substrate transferred via a known roll-to-roll handling method. The substrates is transferred into a washing system that may comprise a process such as plasma cleaning, elastomeric cleaning, ultrasonic cleaning process, etc. The washing cycle may be followed by thin film deposition in physical or chemical vapor deposition vacuum chamber. In this thin film deposition step, which may be referred to as a printing or embossing step, a transparent conductive material, such as Indium Tin Oxide (ITO), is deposited on at least one surface of the substrate. In some embodiments, suitable materials for the conductive lines may include copper (Cu), silver (Ag), gold (Au), nickel (Ni), tin (Sn), Palladium (Pd), and alloys of those metals among others. Depending on the resistivity of the materials used for the circuit, it may have different response times and power requirements. The deposited layer of conductive material may have a resistance in a range of 0.005 micro-ohms to 500 ohms per square, a physical thickness of 100 nm to >10 microns, and a width of 1-50 microns or more. In some embodiments, the printed substrate may have anti-glare coating or diffuser surface coating applied by spray deposition or wet chemical deposition. The substrate may be cured by, for example, heating by infrared heater, an ultraviolet heater convection heater or the like. This process may be repeated and several steps of lamination, etching, printing and assembly may be needed to complete the touch sensor circuit.

The pattern printed may be a high resolution conductive pattern comprising a plurality of lines. In some embodiments, these lines may be microscopic in size. The difficulty of printing a pattern may increase as the line size decreases and the complexity of the pattern geometry increases. The ink used to print features of varying sizes and geometries may also vary, some ink compositions may be more appropriate to larger, simple features and some more appropriate for smaller, more intricate geometries.

In an embodiment, there may be multiple printing stations used to form a pattern. These stations may be limited by the amount of ink that can be transferred on an anilox roll. In some embodiments, there may be dedicated stations to print certain features that may run across multiple product lines or applications, these dedicates stations may, in some cases, use the same ink for every printing job or may be standard features common across several products or product lines which can then be run in series without having to change out the roll. The cell volume of an anilox roll or rolls used in the transfer process, which may vary from 0.5-30 BCM (billion cubic microns) in some embodiments and 9-20 BCM in others, may depend on the type of ink being transferred. The type of ink used to print all or part of a pattern may depend on several factors, including the cross-sectional shape of the lines, line thickness, line width, line length, line connectivity, and overall pattern geometry. In addition to the printing process, at least one curing process may be performed on a printed substrate in order to achieve the desired feature height.

### Master Plate Formation

Flexography is a form of a rotary web letterpress where relief plates are mounted on to a printing cylinder, for example, with double-sided adhesive. These relief plates, which may also be referred to as a master plate or a flexoplate, may be used in conjunction with fast drying, low viscosity solvent, and ink fed from anilox or other two roller inking system. The anilox roll may be a cylinder used to provide a measured amount of ink to a printing plate. The ink may be, for example, water-based or ultraviolet (UV)-curable inks In one example, a first roller transfers ink from an ink pan or a metering system to a meter roller or anilox roll. The ink is metered to a uniform thickness when it is transferred from the anilox roller to a plate cylinder. When the substrate moves through the roll-to-roll handling system from the plate cylinder to the impression cylinder, the impression cylinder applies pressure to the plate cylinder which transfers the image on to the relief plate to the substrate. In some embodiments, there may be a fountain roller instead of the plate cylinder and a doctor blade may be used to improve the distribution of ink across the roller.

Flexographic plates may be made from, for example, plastic, rubber, or a photopolymer which may also be referred to as a UV-sensitive polymer. The plates may be made by laser engraving (ablation), laser cross-linking (polymerization), photomechanical, or photochemical methods. The plates may be purchased or made in accordance with any known method. The preferred flexographic process may be set up as a stack type where one or more stacks of printing stations are arranged vertically on each side of the press frame and each stack has its own plate cylinder which prints using one type of ink and the setup may allow for printing on one or both sides of a substrate. In another embodiment, a central impression cylinder may be used which uses a single impression cylinder mounted in the press frame. As the substrate enters the press, it is in contact with the impression cylinder and the appropriate pattern is printed. Alternatively, an inline flexographic printing process may be utilized in which the printing stations are arranged in a horizontal line and are driven by a common line shaft. In this example, the printing stations may be coupled to curing stations, die-cutters, rewinders, or other post-printing processing equipment. Other configurations of the flexo-graphic process may be utilized as well.

In an embodiment, flexo plate sleeves may be used, for example, in an in-the-round (ITR) imaging process. In an ITR process, the photopolymer plate material is processed on a sleeve that will be loaded on to the press, in contrast with the method discussed above where a flat plate may be mounted to a printing cylinder, which may also be referred to as a conventional plate cylinder. The flexo-sleeve may be a continuous sleeve of a photopolymer with a laser ablation mask coating disposed on a surface. In another example, individual pieces of photopolymer may be mounted on a base sleeve with tape and then imaged and processed in the same manner as the sleeve with the laser ablation mask discussed above. Flexo-sleeves may be used in several ways, for example, as carrier rolls for imaged, flat, plates mounted on the surface of the carrier rolls, or as sleeve surfaces that have been directly engraved (in-the-round) with an image. In the example where a sleeve acts solely as a carrier role, printing plates with engraved images may be mounted to the sleeves, which are then installed into the print stations on cylinders. These pre-mounted plates may reduce changeover time since the sleeves can be stored with the plates already mounted to the sleeves. Sleeves are made from various materials, including thermoplastic composites, thermoset composites, and nickel, and may or may not be reinforced with fiber to resist cracking and splitting. Long-run, reusable sleeves that incorporate a foam or cushion base are used for very high-quality printing. In some embodiments, disposable “thin” sleeves, without foam or cushioning, may be used.

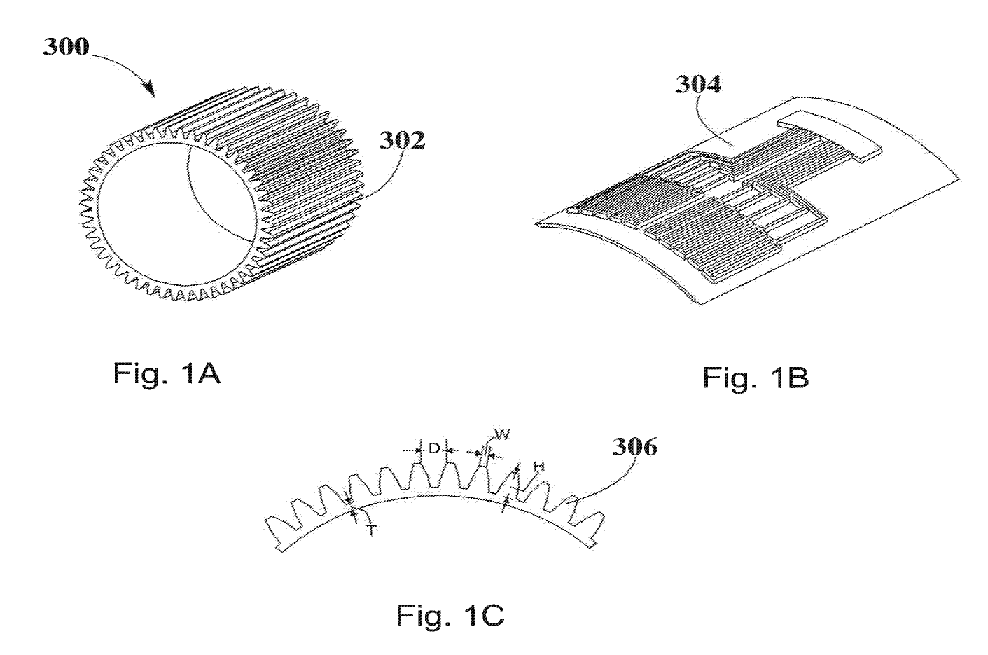

FIGS. 1A-1C are illustrations of flexo-master embodiments. As noted above, the terms “master plate” and “flexo-master” may be used interchangeably. FIG. 1A displays isometric views a flexo-master 300 which is cylindrical and comprises a plurality of horizontally oriented protrusions 302 extending upward from the surface of the flexo-master 300. FIG. 1B depicts an isometric view of an embodiment of a circuit pattern flexo-master 304. FIG. 1C depicts a cross sectional view 306 of a portion of straight lines (protrusions) flexo-master 302 as shown in FIG. 1A. FIG. 1C also depicts “W” which is the width of the flexo-master protrusions, “D,” is the distance between the center points of the protrusions 306 and “H” is the height of the protrusions. The cross-section of the protrusions 306 could be, for example, rectangular, square, half-circles, trapezoids, or other geometries. In an embodiment (not pictured), one or all of D, W, and H may the same or similar measurements across the flexo-master. In another embodiment (not pictured), one or all of D, W, and H may be different measurements across the flexo-master. In an embodiment (not pictured) width W of flexo-master protrusions is between 3 and 5 microns, distance D between adjacent protrusions 1 and 5 mm, height H of the protrusions may vary from 3 to 4 microns and thickness T of the protrusions is between 1.67 and 1.85 mm. In an embodiment, printing may be done on one side of a substrate, for example, using one roll comprising both patterns, or by two rolls each comprising one pattern, and that substrate may be subsequently cut and assembled. In an alternate embodiment, both sides of a substrate may be printed, for example, using two different print stations and two different flexo-masters. Flexo-masters may be used, for example, because printing cylinders may be expensive and hard to change out, which would make the cylinders efficient for high-volume printing but may not make that system desirable for small batches or unique configurations. Changeovers may be costly due to the time involved. In contrast, flexographic printing may mean that ultraviolet exposure can be used on the photo plates to make new plates that may take as little as an hour to manufacture. In an embodiment, using the appropriate ink with these flexo-masters may allow the ink to be loaded from, for example, a reservoir or a pan in a more controlled fashion wherein the pressure and surface energy during ink transfer may be able to be controlled. The ink used for the printing process may need to have properties such as adhesion, viscosity, weight % particulate (solids content), and UV-curability so that the ink stays in place when printed and does not run, smudge, or otherwise deform from the printed pattern prior to exposure to UV radiation. The ink properties further act to promote accurate sometimes microscopic geometries wherein the ink joins together to form the desired features. In some embodiments, the ink may comprise a catalyst that is conducive to plating that acts as seed layer during, for example, electroless plating. Each pattern may, for example, be made using a recipe wherein the recipe comprises at least one flexo-master and at least one type of ink. Different resolution lines, different size lines and spaces (spacing), and different geometries, for example may require different recipes.

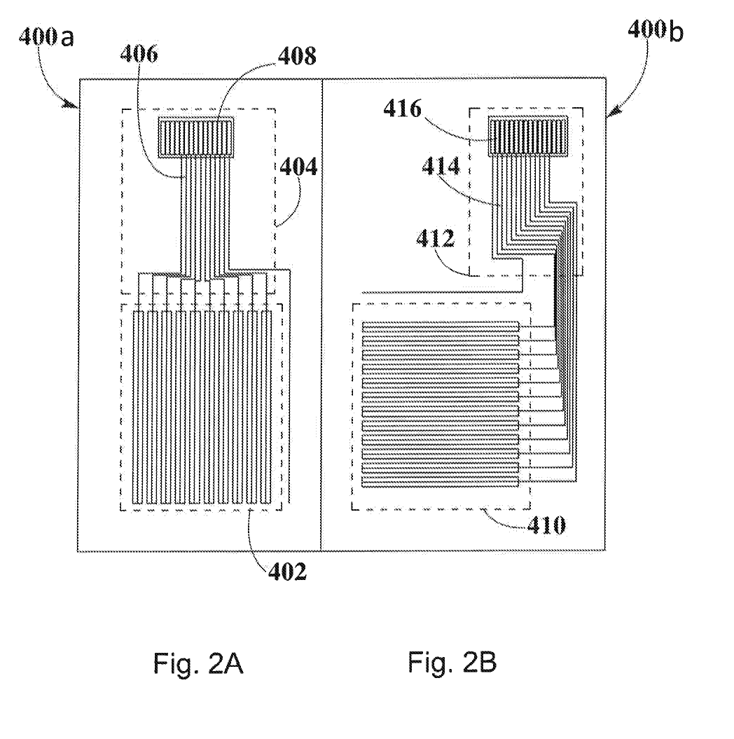

FIG. 2A depicts the top views at 400a of a first to be printed on one side of thin flexible transparent substrates. A first pattern 400a may be printed on one side of a first flexible substrate, including a plurality of lines 402 that may constitute the Y oriented segment of an X-Y grid, and tail at block 404 comprising a plurality of electrical leads 406 and a plurality of electrical connectors at block 408. FIG. 2B depicts an embodiment of a second pattern 400b which may be printed on one side of a second flexible substrate, comprising a plurality of lines at block 410 that may constitute the X oriented segment of an X-Y grid (not pictured) and tail at block 412 comprising electrical leads at block 414 and electrical connectors at block 416.

### Printing of High Resolution Conductive Lines

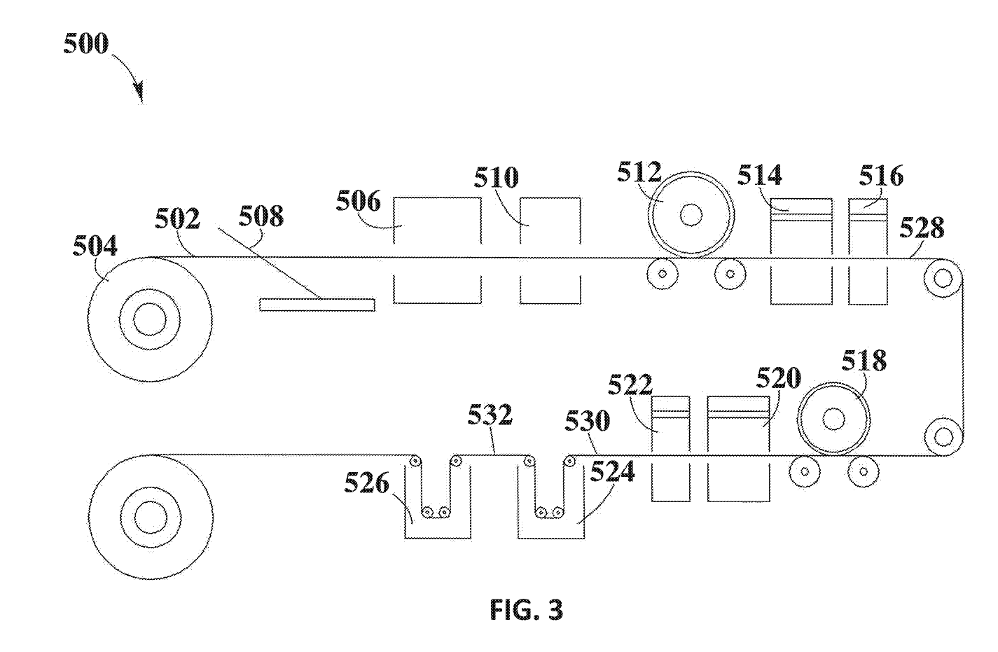

FIG. 3 is an embodiment of a system for fabricating a conductive microscopic pattern on a flexible dielectric substrate. The system 500 may be used to fabricate a touch sensor circuit in accordance with various embodiments of the invention. Following the process, an elongated, transparent, flexible, thin dielectric substrate 502 is placed on unwind roll 504. Any of a variety of transparent flexible dielectrics may be used. In some embodiments, PET (polyethylene terephthalate) is one transparent dielectric which may be used. By way of additional examples, acrylics, polyurethanes, epoxy's, polyimides and various combinations of the aforementioned dielectric materials may be used.

The thickness of dielectric substrate 502 should preferably be small enough to avoid excessive stress during flexing of the touch sensor and, in some embodiments, to improve optical transmissivity. A dielectric substrate that is too thin may jeopardize the continuity of this layer or its material properties during the manufacturing process. In some embodiments, a thickness between 1 micron and 1 millimeter may be sufficient. Thin dielectric substrate 502 may be transferred, via any known roll to roll handling method, from unwind roll 504 to a first cleaning station 506 (e.g., a web cleaner). As a roll to roll process involves a flexible substrate, the alignment between the substrate and the flexographic master plate 512 may be somewhat challenging. The printing of high resolution lines may be more readily performed if the correct alignment is maintained during the printing process. In an embodiment, positioning cable 508 is used to maintain the right alignment of these two features, in other embodiments other means may be used for this purpose. In some embodiments a first cleaning station 506 comprises a high electric field ozone generator. Ozone which may be generated may then be used to remove impurities, for example, oils or grease, from dielectric substrate 502.

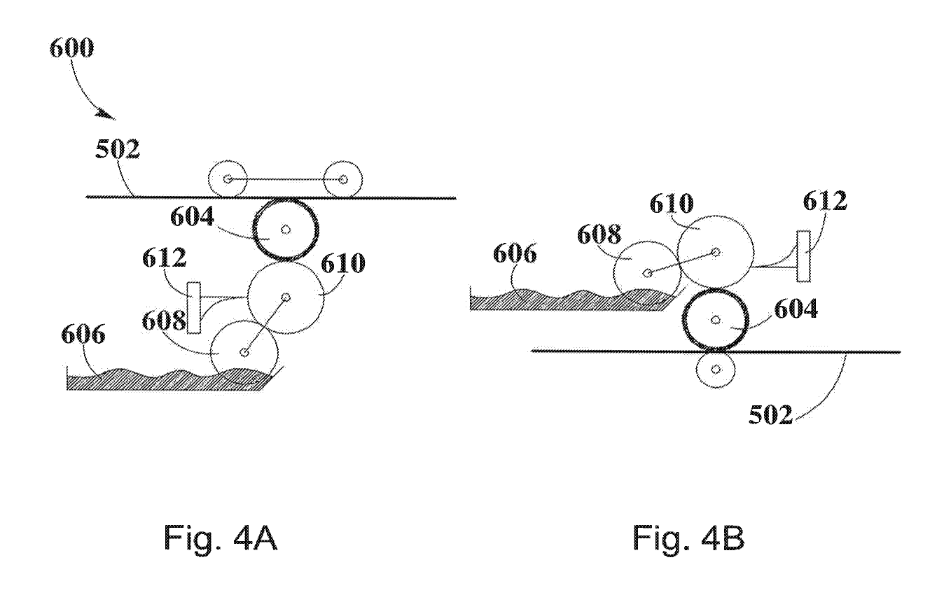

Dielectric substrate 502 then may pass through a second cleaning system 510 The second cleaning station 510 may comprise a web cleaner. The first and the second cleaning systems may be the same or different types of systems. After these cleaning stages, dielectric substrate 502 may go through a first printing process where a microscopic pattern is printed on one of the sides of dielectric substrate 502. The microscopic pattern is imprinted by a master plate 512 using UV curable ink that may have a viscosity between 200 and 2000 cps, but not limited to this range of viscosity. Further, the microscopic pattern may be conformed by lines having a width, for example, between 1 and 20 microns or wider. This pattern may be similar to the first pattern shown in FIG. 4. In some embodiments the amount of ink transferred from master plate 512 to dielectric substrate 502 is regulated by a high precision metering system and depends on the speed of the process, ink composition and patterns shape and dimension. In an embodiment, the speed of the machine may vary from less than 20 feet per minute (fpm) to 750 fpm, and in some embodiments it may vary from 50 fpm to 200 fpm. In an embodiment, the ink may contain plating catalysts. In an embodiment, the first printing station may be followed by a curing station. Top patterned lines 528 are formed on top of the dielectric substrate 502. The curing station 514 may comprise, for example, an ultraviolet light cure with target intensity from about 0.5 mW/cm² to about 50 mW/cm² and wavelength from about 280 nm to about 480 nm. In an embodiment, the curing station 516 may comprise an oven heating module that applies heat within a temperature range of about 20° C. to about 125° C. In addition to or as an alternative to 514 and 516, other curing stations may be employed as well.

Following FIG. 2, in some embodiments the bottom side of dielectric substrate 502 without printed lines may then go through a second printing station. A microscopic pattern may be printed on the bottom side of dielectric substrate 502. The microscopic pattern may be imprinted by a second master plate 518 using UV curable ink. A pattern similar to the second (right side) pattern shown in FIG. 2 may be used. The amount of ink transferred from second master plate 518 to bottom side of dielectric substrate 502 may also be regulated by a high precision metering system. This second printing station may be followed by a curing step. The curing may, for example, comprise ultraviolet light curing station 520 with target intensity from about 0.5 mW/cm² to about 50 mW/cm² and wavelength from about 280 nm to about 580 nm. Additionally or alternatively, the curing may comprise an oven heating station 522 that applies heat within a temperature range of about 20° C. to about 125° C., other curing station may be employed as well. After the second curing step, bottom patterned lines are formed by printing at print station 530 on the bottom of the dielectric substrate 502.

### Electro-Less Plating

With printed microscopic patterns on both sides, top patterned lines 528 and bottom patterned lines 530, dielectric substrate 502 may be exposed to electroless plating station 524. In this step a layer of conductive material is deposited on the microscopic patterns. This may be accomplished by submerging top patterned lines printed at print station 528 and bottom patterned lines printed at print station 530 of dielectric substrate 502 into a plating tank at electroless plating station 524 that may contain compounds of copper or other conductive material in a solution form at a temperature range between 20° C. and 90° C. (e.g., 40° C.). In one example, the deposition rate of the conductive material may be 10 nanometers per minute and within a thickness of about 0.001 microns to about 100 microns, depending on the speed of the web and according to the application requirements. This electroless plating process does not require the application of an electrical current and it only plates the patterned areas containing plating catalysts that were previously activated by the exposition to UV and/or thermal radiation during the curing process. In other embodiments, nickel is used as the plating metal. The copper plating bath may include powerful reducing agents in it, such as formaldehyde, borohydride or hypophosphite, which cause the plating to occur. The plating thickness tends to be uniform compared to electroplating due to the absence of electric fields. Although electroless plating is generally more time consuming than electrolytic plating, electroless plating is well suited for parts with complex geometries and/or many fine features. After the plating step, the capacitive touch sensor circuit 532 has been printed on both sides of dielectric substrate 502.

In some embodiments a washing station 526 follows electroless plating 524. After the plating station 524, capacitive touch sensor circuit 532 may be cleaned by being submerged into a cleaning tank that contains water at room temperature and then possibly dried through the application of air at room temperature. In another embodiment, a passivation step in a pattern spray may be added after the drying step to prevent any dangerous or undesired chemical reaction between the conductive materials and water.

### Precision Metering System

FIGS. 4A and 4B illustrate embodiments of a high precision metering system. High precision ink metering system 600 may control the exact amount of ink that is transferred to substrate 502 by master plate 604 as described in both printing steps of manufacturing method 500 in FIG. 3. FIG. 4A depicts a metering system for printing on one (top) side of a substrate. FIG. 4B depicts a metering system for printing on the other (bottom) side of the substrate. In some embodiments, the two systems may be used in conjunction. Both systems comprises ink pan 606, transfer roll 608, anilox roll 610, doctor blade 612 and master plate 604. A portion of the ink contained in ink pan 606 may be transferred to anilox roll 610, possibly constructed of a steel or aluminum core which may be coated by an industrial ceramic whose surface contains millions of very fine dimples, known as cells. Depending on the design of the printing process, anilox roll 610 may be either semi-submersed in ink pan 606 or comes into contact with a transfer roll 608. Doctor blade 612 may be used to scrape excess ink from the surface leaving just the measured amount of ink in the cells. The roll then rotates to contact with the flexographic printing plate (master plate 604) which receives the ink from the cells for transfer to substrate 502. The rotational speed of master plate 604 should preferably match the speed of the web, which may vary between 20 fpm and 750 fpm. It should be noted that the differences between systems 4A and 4B are the location from where substrate 502 is fed and how master plate 604 and anilox roll 610 are configured. In FIG. 4A, the substrate 502 is fed through the top of the system, and master plate 604 is disposed underneath substrate 502 and on top of anilox roll 610. This is in contrast to FIG. 4B, where substrate 502 is fed through the bottom of the system and master plate 604 is disposed on top of substrate 502 and underneath anilox roll 610.

### Final Product Film

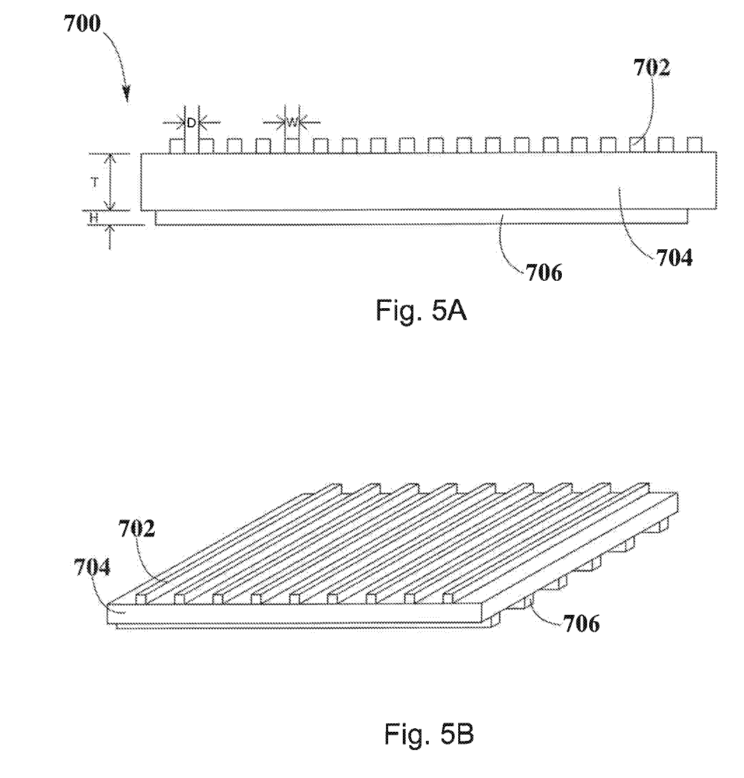

FIG. 5A is an embodiment of a cross sectional view 700, which is an embodiment of a capacitive touch sensor circuit 532. FIG. 5B is an embodiment of an isometric view of a capacitive touch sensor 532. Shown in this figure are top electrodes 702 formed on the top side and bottom electrodes 706 formed on the bottom side of dielectric layer 704. In some embodiments, with the above electrode metal configuration, circuits consuming 75% less power than those using ITO (Indium Tin Oxide) may be achieved. In one particular embodiment the width W of the printed electrodes varies from 5 to 10 microns with a tolerance of +/−10%. The spacing D between the lines may vary from about 200 microns to 5 mm. Spacing D and width W may be functions of the size of the display and desired resolution of the sensor. Height H may range from about 150 nanometers to about 6 microns. The pattern may be configured as to produce a printed pattern with line thickness from 1 micron-20 microns or greater. The dielectric layer 704 may exhibit thickness T between 1 micron and 1 millimeter and a preferred surface energy from 20 Dynes/cm to 90 Dynes/cm. In an embodiment, the protrusions depicted by top electrodes 702 and bottom electrodes 706 may have a cross-sectional geometry of a square, rectangle, half-circle, triangle, trapezoid, etc.

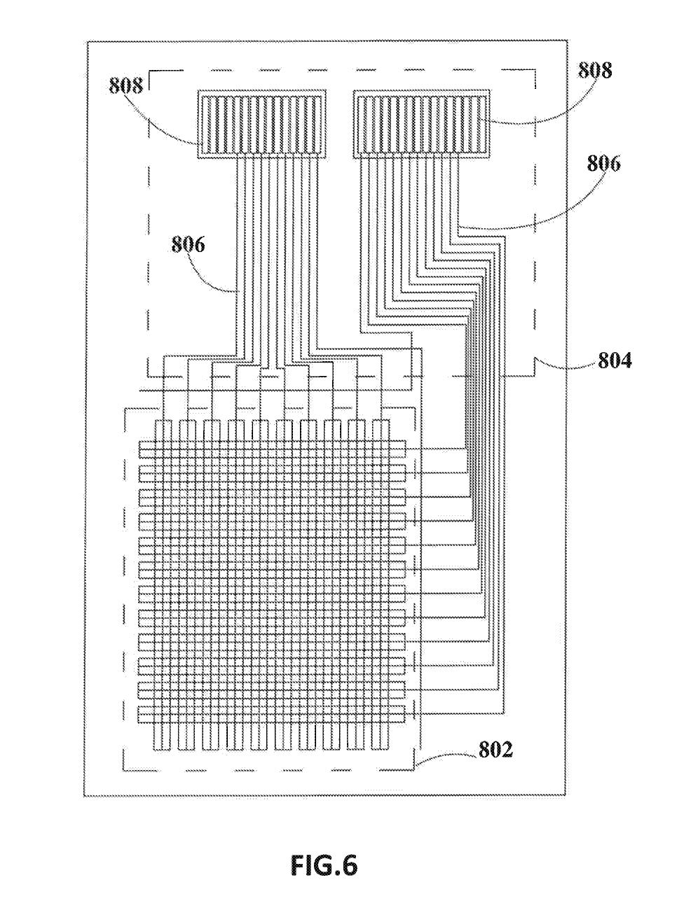

FIG. 6 is a top view of an embodiment of a circuit printed on a thin flexible transparent substrate. Shown in this figure are conductive grid lines 802 which comprise the electrodes and tail 804 comprising electrical leads 806 and electrical connectors 808. These electrodes may conform an x-y grid, that enables the recognition of the point where the user has interacted with the sensor. This grid may have 16×9 conductive lines or more and a size range from 2.5 mm by 2.5 mm to 2.1 m by 2.1 m. Conductive lines corresponding to the Y axis may have been printed on the first side of the dielectric layer and conductive lines corresponding to the X axis may have been printed on the second side of the dielectric layer.

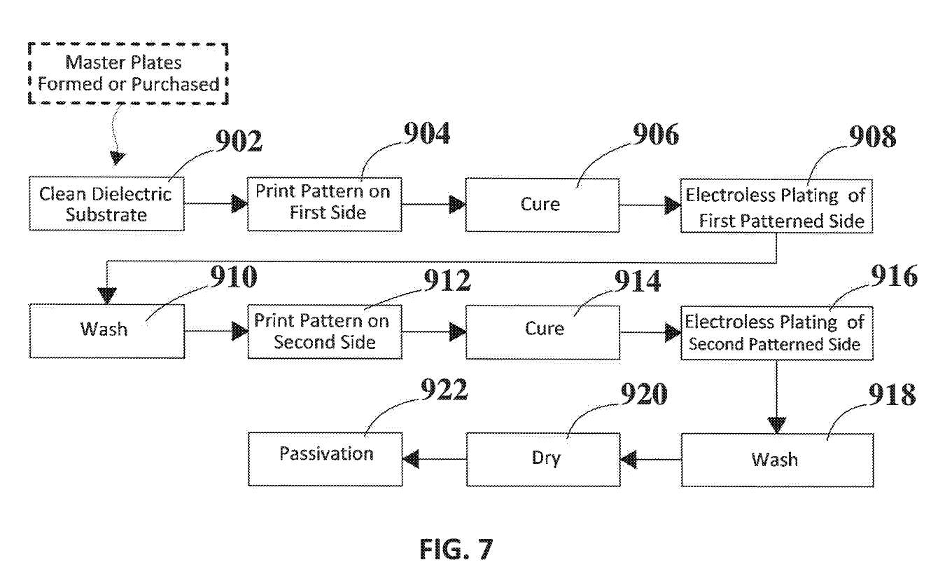

FIG. 7 is embodiment of a method of manufacturing a mutual capacitance touch sensor. First, a dielectric substrate is cleaned 902, and a first conductive microstructural pattern is printed on a first side of the substrate 904. The substrate may be a transparent flexible dielectric. Transparent flexible dielectrics available in the market and known in the art may be used. In some embodiments, PET (polyethylene terephthalate) is one transparent dielectric which may be used. Also, for example, acrylics, polyurethanes, epoxy's, polyimides and various combinations of the aforementioned dielectric materials, or paper may be used, depending on the application. To be considered an opaque conductive material, the material may comprise a plurality of small, opaque structures that are not easily detected by the naked eye. A conductive microstructural pattern may be an opaque conductive material patterned on a non-conductive substrate, wherein “opaque” refers to a material that may be less than 50% transparent.

A first master plate is used to print the first side of the dielectric substrate at printing station 904 using ink that may contain a plating catalyst. A master plate may be any roll that has a predefined pattern imprinted on it which is used to print that pattern on any substrate. A plating catalyst enables a chemical reaction in the plating process. In some embodiments, the contact pressure between the master plate and the substrate, which may correspond to the viscosity and composition of the ink, should be configured so that maximum resolutions are achieved during the printing process. The ink may further be a combination of monomers, oligomers, or polymers, metal elements, metal elements complexes, or organometallics in a liquid state that may be discretely applied over a substrate surface. An anilox roll is a cylinder that may be used to provide a measured amount of ink to a master plate. After printing the first side of the substrate 904, the substrate is cured at curing station 906 using either ultraviolet light or an oven heating process. Curing may refer to the process of drying, solidifying, or fixing any previously applied coating or ink imprint on to a substrate. In an embodiment (not pictured), only ultraviolet light may be used. In an embodiment, the first patterned side of the substrate is plated 908, for example, by electroless plating, and then washed 910 before a second pattern is printed 912 on a second side of the substrate. Electroless plating is a process where a layer of conductive material is deposited on to the microscopic patterns printed using the master plates. The conductive material used may be, for example, solutions of copper or nickel compounds. The conductive material may have a resistance in a range of 0.005 micro-ohms to 500 ohms per square, a physical thickness of 100 nm to >10 microns, and a width of 1-50 microns or more. Only the patterned areas are plated because those areas contain plating catalysts which may, as described above, have been contained in the ink used during the substrate printing process. After the first patterned side of the substrate has been plated in the electroless plating process 908, the substrate is washed 910. In an embodiment, a second pattern may be printed 912 using a different master plate than the first pattern, and may, in some embodiments, be printed using a different ink than used for the first pattern printed at 904. The second pattern may then be cured with curing process 914 and plated 916. The substrate may then be washed in washing process 918 and dried in drying process 920. In some embodiments, the substrate may undergo passivation process 922. In an alternate embodiment, a second master plate is used to print a second conductive microstructural pattern 912 on a second side of the substrate. The second master plate may contain a pattern that is different from the first plate. The substrate may then be cured again at curing station 914. The substrate may then be washed 918, for example, in a water wash at wash station 918 at room temperature, and dried at drying station 920. The wash may be a web cleaner which is used in web manufacturing to remove particles from a substrate or a web.

In a preferred embodiment, the printing and plating is performed simultaneously or in series on both sides of the film. While this embodiment is not pictured, the functions of the processing stations is the same as or similar to those in FIG. 7. In this example, the film is cleaned at a first cleaning station 902 wherein both sides are cleaned simultaneously or in series by at least one of a web cleaner or a high electric field ozone generator. The first side of the film is printed by flexographic printing at a printing station 904, wherein a pattern comprising a plurality of lines and a tail is printed using ink. The first printed pattern is then cured at a curing station 906 comprising at least one of a UV cure or an oven cure. After the first printed pattern has been cured, the second side is printed at printing station 912 and cured at curing station 906. Subsequent to printing both sides at printing stations 904 and 912, the substrate is again washed 910 at a second cleaning station that cleans both sides of the substrate. Following the wash, both the first and the second side are plated simultaneously at plating station 908. Subsequent to plating at plating station 908, the substrate may undergo a third wash cycle 918, dry at a drying station 920, and may undergo passivation at passivation station 922.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed:

1. A method of producing a mutual capacitance touch sensor by flexographic printing comprising:
cleaning a dielectric substrate;
printing a first pattern on a first side of the dielectric substrate, wherein the first pattern is printed using a first master plate;
curing the printed dielectric substrate;
printing a second pattern on a second side of the dielectric substrate, wherein the second pattern is printed using a second master plate.

2. The method of claim 1, wherein printing the first and the second sides of the dielectric substrate comprises depositing, by an electroless plating process, a conductive material on the first and the second patterns.

3. The method of claim 2, wherein the conductive material comprises at least one of copper (Cu), silver (Ag), gold (Au), nickel (Ni), tin (Sn) and Palladium (Pd), or alloys thereof.

4. The method of claim 1, wherein the first pattern is printed using a first ink, and the second pattern is printed using a second ink, wherein the first and the second ink each comprise at least one plating catalyst.

5. The method of claim 1, wherein the substrate is at least one of a polyethylene terephthalate (PET), an acrylic, a polyurethane, an epoxy, and a polyimide.

6. The method of claim 1, wherein the substrate undergoes a passivation process.

7. The method of claim 1, wherein the first pattern comprises a first plurality of lines, and wherein the second pattern comprises a second plurality of lines.

8. A method of producing a mutual capacitance touch sensor comprising a dielectric substrate;
printing, by a flexographic printing process using at least a first master plate and a first ink, a first pattern on a first side of a dielectric substrate;
curing the printed dielectric substrate;
printing, by a flexographic printing process using at least a second master plate and a second ink, a second pattern on a second side of the dielectric substrate, wherein the second pattern is printed using a second master plate and a second ink;
curing, subsequent to printing the second pattern, the printed dielectric substrate; and
depositing, by an electroless plating process, a conductive material on the first and the second patterned surfaces.

9. The system of claim 8, wherein the pattern of the first master plate is different from the pattern of the second master plate.

10. The method of claim 8, wherein at least two master plates of a plurality of master plates are used to print at least one of the first pattern and the second pattern.

11. The method of claim 8, wherein the ink used to print with the first plate of the at least two master plates is different than the ink used to print with at least one of the other master plates of the plurality of master plates.

12. The system of claim 11, wherein the plating is electroless plating, and wherein the conductive material is at least one of copper or nickel.

13. A method of producing a mutual capacitance touch sensor by flexographic printing comprising:
printing, by a first print module, a first pattern on a first side of the dielectric substrate;
curing the printed dielectric substrate;
depositing, by an electroless plating process, a conductive material on the first patterned surface;
printing, by a second print module, a second pattern on a second side of the dielectric substrate;
curing, subsequent to printing the second pattern, the printed dielectric substrate;
depositing, by the electroless plating process, a conductive material on the second micro structural pattern.

14. The method of claim 13, wherein the conductive material comprises at least one of copper (Cu), silver (Ag), gold (Au), nickel (Ni), tin (Sn), and Palladium (Pd).

15. The method of claim 13, wherein at least one of the first print module and the second comprises at least one master plate of a plurality of master plates.

16. The method of claim 13, wherein at least one of the first print module and the second print module comprises at least two master plates.

17. The method of claim 13, wherein at least one of the first print module and the second print module comprises one master plate.

18. The method of claim 13, wherein a first ink is used to print the first pattern and a second ink is used to print the second pattern.

19. The method of claim 18, wherein the first and the second ink each contain at least one plating catalyst.

20. The method of claim 19, wherein the first ink and the second ink contain different catalysts.
